(19) United States
(12) Patent Application Publication
(10) Pub. No.: US 2013/0268985 A1
(43) Pub. Date: Oct. 10, 2013

(54) APPARATUS AND METHOD FOR TRANSMITTING AND RECEIVING CHANNEL ADAPTIVE HIERARCHICAL BROADCAST

(71) Applicant: Electronics and Telecommunications Research Institute, (US)

(72) Inventors: Chang Ki KIM, Daejeon (KR); Tae Jung KIM, Cheongju-si (KR); Jeong Ju YOO, Daejeon (KR); Young Ho JEONG, Daejeon (KR); Jin Woo HONG, Daejeon (KR)

(73) Assignee: Electronics and Telecommunications Research Institute, Daejeon (KR)

(21) Appl. No.: 13/857,500

(22) Filed: Apr. 5, 2013

(30) Foreign Application Priority Data
Apr. 5, 2012 (KR) 10-2012-0035533

(51) Int. Cl. H04N 21/2385

(52) U.S. Cl. CPC H04N 21/2385
USPC 725/109

(57) ABSTRACT

An apparatus and method for transmitting and receiving a channel adaptive hierarchical broadcast are provided. A channel adaptive hierarchical broadcast transmission apparatus may include a multilayer video dividing unit to divide an input multilayer video bitstream into a first layer video bitstream and a second layer video bitstream, and a multi-transmission channel managing unit to determine transmission channels that are to be used to transmit the first layer video bitstream and the second layer video bitstream, among multiple transmission channels, and to output the first layer video bitstream and the second layer video bitstream to transmitters associated with the determined transmission channels, respectively.

### CROSS-REFERENCE TO RELATED APPLICATION

This application claims the benefit of Korean Patent Application No. 10-2012-0035533, filed on Apr. 5, 2012, in the Korean Intellectual Property Office, the disclosure of which is incorporated herein by reference.

### BACKGROUND

1. Field of the Invention

The present invention relates to an apparatus and method for transmitting and receiving a transmission channel adaptive hierarchical broadcast, and more particularly, to an apparatus and method that may provide an optimum broadcast service using multiple transmission channels.

2. Description of the Related Art

As current information technologies (IT) develop, conventional broadcasting that has been independently evolved, and communication infrastructure and services are being rapidly changed to a fusion environment, to provide users with high-quality real-time services. In particular, due to commercialization of Internet protocol televisions (IPTVs), TVs at homes also are being provided with high-quality services through multiple transmission channels, that is, various broadcast and multimedia services through IP networks, in addition to through conventional terrestrial transmission channels. Additionally, as a number of networks usable in a single terminal increases with an advent of various smart terminals, a transmission technology using multiple wireless transmission channels is being used. Users may further request high-speed multimedia services.

Services using current multiple transmission channels provide various services, compared to services provided using a single channel in a single reception apparatus. However, when a service is provided using a single channel, data transmission may be interrupted or a part of the data may not be transmitted, based on a change in a state of the channel (for example, a reduction in a bandwidth), and accordingly a quality of the service may be reduced.

Accordingly, there is a need for an apparatus and method for providing users with broadcast and multimedia services that are improved compared to conventional services, by seamlessly transmitting broadcast and multimedia data adaptively based on a change in a state of a channel, by simultaneously using current multiple transmission channels for a single service to meet a user's request for a high-quality multimedia service, together with a method of using a single transmission channel for a single service among the current multiple transmission channels.

### SUMMARY

An aspect of the present invention is to solve conventional problems of interruption of a service and deterioration in a service quality that are caused by using a single channel, by providing a channel adaptive hierarchical broadcast and multimedia service using multiple transmission channels.

Another aspect of the present invention is to provide a high-quality service, by enabling transceiving of hierarchical broadcast and multimedia data by expanding a channel bandwidth of a user (namely, a reception apparatus), using adaptive multiple channels for a single service.

According to an aspect of the present invention, there is provided a channel adaptive hierarchical broadcast transmission apparatus, including: a multilayer video dividing unit to divide an input multilayer video bitstream into a first layer video bitstream and a second layer video bitstream; and a multi-transmission channel managing unit to determine transmission channels that are to be used to transmit the first layer video bitstream and the second layer video bitstream, among multiple transmission channels, and to output the first layer video bitstream and the second layer video bitstream to transmitters associated with the determined transmission channels, respectively.

According to another aspect of the present invention, there is provided a channel adaptive hierarchical broadcast reception apparatus, including: a receiver to receive a first layer video bitstream and a second layer video bitstream from a channel adaptive hierarchical broadcast transmission apparatus, via multiple transmission channels; a video synchronization processor to extract synchronization information from each of the first layer video bitstream and the second layer video bitstream, to combine the first layer video bitstream and the second layer video bitstream using the extracted synchronization information, and to generate a multilayer video bitstream; and a display processor to display the generated multilayer video bitstream. Here, the channel adaptive hierarchical broadcast reception apparatus may include, for example, a set-top box (STB) of a smart television (TV).

### EFFECT

According to embodiments of the present invention, an apparatus and method for transmitting and receiving a channel adaptive hierarchical broadcast may transmit hierarchical broadcast and multimedia data based on a state of a channel, using multiple transmission channels in different networks or in the same network, and accordingly it is possible to complement an error that may occur in transmission of current broadcast and multimedia data, and is also possible to provide a better high-quality broadcast and multimedia service by expanding a bandwidth of a reception apparatus while maintaining compatibility with an apparatus used to transmit the current broadcast and multimedia data.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a channel adaptive hierarchical broadcast transmission apparatus using multiple transmission channels according to an embodiment of the present invention;

FIG. 2 is a block diagram illustrating a configuration of a channel adaptive hierarchical broadcast reception apparatus using multiple transmission channels according to an embodiment of the present invention;

FIG. 3 is a diagram illustrating a structure of a protocol used between a channel adaptive hierarchical broadcast transmission apparatus and a channel adaptive hierarchical broadcast reception apparatus using multiple transmission channels according to an embodiment of the present invention;

FIG. 4 is a flowchart illustrating a channel adaptive hierarchical broadcast transmission method using multiple transmission channels according to an embodiment of the present invention; and

FIG. 5 is a flowchart illustrating a channel adaptive hierarchical broadcast reception method using multiple transmission channels according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

In a basic principle for transceiving of a channel adaptive hierarchical broadcast using multiple transmission channels, a transmission apparatus and a reception apparatus may transmit and receive first data (for example, a video bitstream of a first layer), via a first transmission channel, and may transmit and receive second data (for example, a video bitstream of a second layer), via a second transmission channel. In this instance, the reception apparatus may synchronize and combine the first data with the second data for an improved high-quality broadcast and video service, and may retransmit the first data and the second data to a neighboring smart device. Hereinafter, the video bitstream of the first layer, and the video bitstream of the second layer may be referred to as a ‘first layer video bitstream’ and a ‘second layer video bitstream,’ respectively.

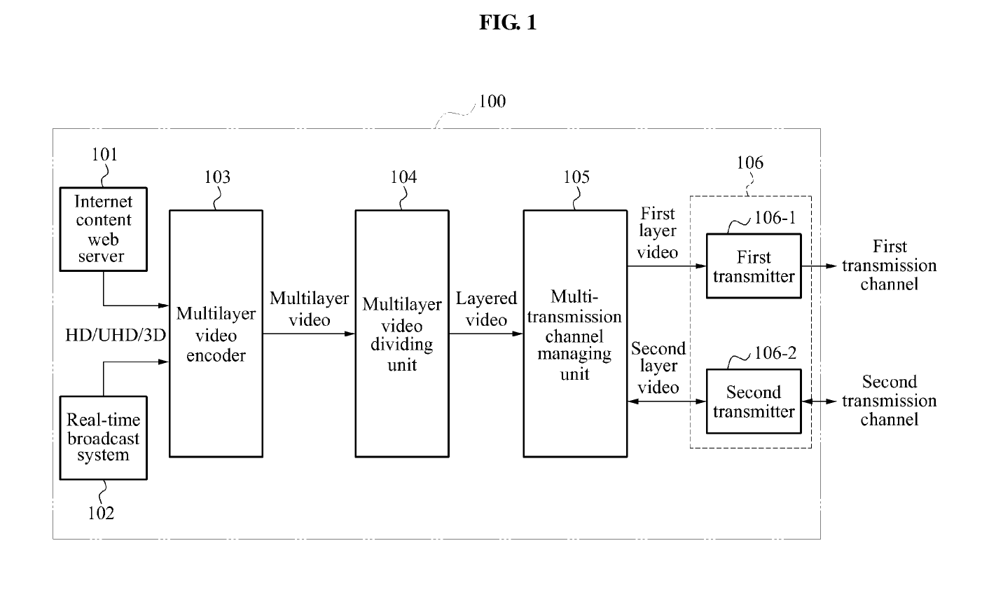

FIG. 1 is a block diagram illustrating a configuration of a channel adaptive hierarchical broadcast transmission apparatus using multiple transmission channels according to an embodiment of the present invention.

Referring to FIG. 1, a channel adaptive hierarchical broadcast transmission apparatus 100 using multiple transmission channels may be applied to a broadcast and video transmission apparatus. The channel adaptive hierarchical broadcast transmission apparatus 100 may include a multilayer video encoder 103, a multilayer video dividing unit 104, a multi-transmission channel managing unit 105, and a transmitter 106. Additionally, the channel adaptive hierarchical broadcast transmission apparatus 100 may further include an Internet content web server 101 and a real-time broadcast system 102.

The Internet content web server 101 and the real-time broadcast system 102 may provide, in real time or non-real time, a video source, for example, high definition (HD) video data, ultra high definition (UHD) video data, and three-dimensional (3D) video data.

The multilayer video encoder 103 may be a standardized standard codec of moving picture experts group (MPEG) used to receive a video source and to encode the received video source to a multilayer video bitstream. The multilayer video encoder 103 may encode the video source to a single multilayer video bitstream divided into a predetermined number of layers, and may output the multilayer video bitstream.

The multilayer video dividing unit 104 may divide the multilayer video bitstream received from the multilayer video encoder 103 into a first layer video bitstream and a second layer video bitstream, to transmit the received multilayer video bitstream to physically different channels. In this instance, the multilayer video dividing unit 104 may divide the multilayer video bitstream based on layers, and may generate an upper layer and a lower layer as the first layer video bitstream and the second layer video bitstream, respectively.

The second layer video bitstream may include additional data for enhanced broadcasting (namely, metadata for additional services, for example multilingual subtitles, personal information, and the like), as well as video.

The multi-transmission channel managing unit 105 may receive the first layer video bitstream and the second layer video bitstream from the multilayer video dividing unit 104, may determine transmission channels that are to be used to transmit the first layer video bitstream and the second layer video bitstream, among the multiple transmission channels, and may output the first layer video bitstream and the second layer video bitstream to transmitters associated with the determined transmission channels, respectively. The multiple transmission channels may include, for example, a first transmission channel based on a broadcast network, and a second transmission channel based on an Internet network. In this instance, the multi-transmission channel managing unit 105 may receive channel information regarding the multiple transmission channels from a channel adaptive hierarchical broadcast reception apparatus, and may determine a transmission channel that is to be used to transmit each of the first layer video bitstream and the second layer video bitstream, based on the received channel information.

For example, the multi-transmission channel managing unit 105 may determine the first transmission channel as a transmission channel to be used to transmit the first layer video bitstream, and may determine the second transmission channel as a transmission channel to be used to transmit the second layer video bitstream.

Accordingly, to transmit the first layer video bitstream via the first transmission channel (for example, the broadcast network), the multi-transmission channel managing unit 105 may output the first layer video bitstream to a first transmitter 106-1 associated with the first transmission channel. Additionally, to transmit the second layer video bitstream via the second transmission channel (for example, the Internet network), the multi-transmission channel managing unit 105 may output the second layer video bitstream to a second transmitter 106-2 associated with the second transmission channel.

The first transmitter 106-1 and the second transmitter 106-2 may be included in the transmitter 106, as shown in FIG. 1.

The first transmitter 106-1 may process a transmission protocol used to transmit the first layer video bitstream, and may transmit the first layer video bitstream via the first transmission channel. In this instance, the first transmitter 106-1 may add, to the first layer video bitstream, at least one of synchronization information for synchronization with the second layer video bitstream, information on hierarchy of the first layer video bitstream, and information regarding whether additional data is included the first layer video bitstream, and may transmit the first layer video bitstream including the at least one information.

The second transmitter 106-2 may process a transmission protocol used to transmit the second layer video bitstream, and may transmit the second layer video bitstream via the second transmission channel. Additionally, the second transmitter 106-2 may add, to the second layer video bitstream, at least one of synchronization information for synchronization with the first layer video bitstream, information on hierarchy of the second layer video bitstream, and information regarding whether additional data is included the second layer video bitstream, and may transmit the second layer video bitstream including the at least one information.

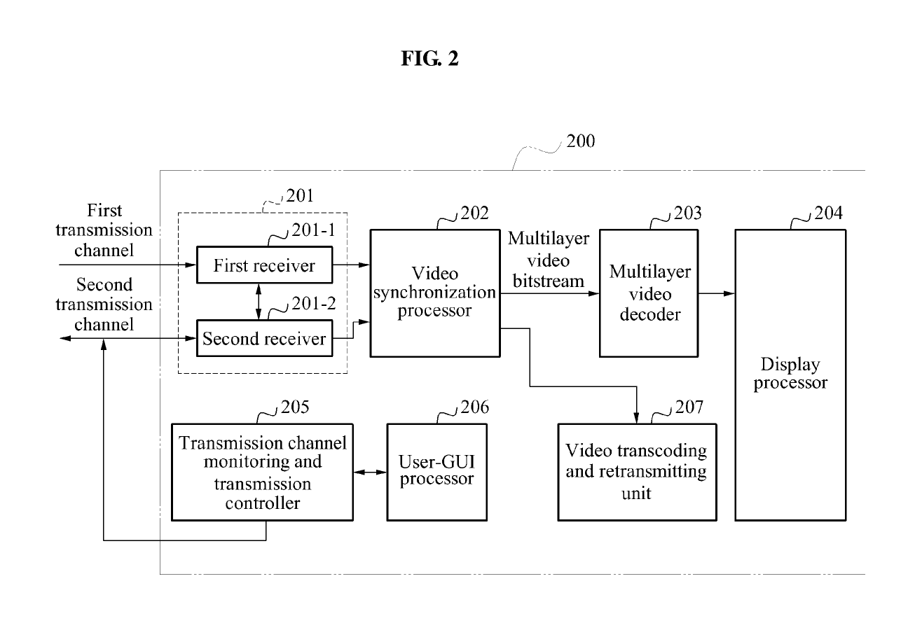

FIG. 2 is a block diagram illustrating a configuration of a channel adaptive hierarchical broadcast reception apparatus using multiple transmission channels according to an embodiment of the present invention.

Referring to FIG. 2, a channel adaptive hierarchical broadcast reception apparatus 200 using multiple transmission channels may be applied to a broadcast and video reception apparatus. The channel adaptive hierarchical broadcast reception apparatus 200 may include a receiver 201, a video synchronization processor 202, a multilayer video decoder 203, a display processor 204, a transmission channel monitoring and transmission controller 205, a user-graphical user interface (GUI) processor 206, and a video transcoding and retransmitting unit 207.

The receiver 201 may include a first receiver 201-1 and a second receiver 201-2.

The first receiver 201-1 may receive a first layer video bitstream from a channel adaptive hierarchical broadcast transmission apparatus, via a first transmission channel (for example, a broadcast network), using a transmission protocol suitable for the first transmission channel.

The second receiver 201-2 may receive a second layer video bitstream from the channel adaptive hierarchical broadcast transmission apparatus, via a second transmission channel (for example, an Internet network), using a transmission protocol suitable for the second transmission channel.

The video synchronization processor 202 may receive the first layer video bitstream and the second layer video bitstream, and may combine the first layer video bitstream and the second layer video bitstream using synchronization information extracted from each of the first layer video bitstream and the second video bitstream, to generate a single multilayer video bitstream.

The multilayer video decoder 203 may receive the generated multilayer video bitstream from the video synchronization processor 202, and may decode the received multilayer video bitstream.

The display processor 204 may receive the decoded multilayer video bitstream from the multilayer video decoder 203, and may display the multilayer video bitstream on a screen of a user.

The transmission channel monitoring and transmission controller 205 may monitor a state of a transmission channel of each of the first receiver 201-1 and the second receiver 201-2, and may transmit channel information obtained by the monitoring to the channel adaptive hierarchical broadcast transmission apparatus. Additionally, the transmission channel monitoring and transmission controller 205 may transmit a request for additional information from the user-GUI processor 206 to the channel adaptive hierarchical broadcast transmission apparatus.

The user-GUI processor 206 may provide, based on a user's preference, a user selection screen for additional data, such as information regarding whether layered video is received, personal information association with broadcasting, a previous summary, stadium information, and the like. The user-GUI processor 206 may generate a request for additional information based on an input of a selection screen, and may transmit the generated request to the channel adaptive hierarchical broadcast transmission apparatus through the transmission channel monitoring and transmission controller 205.

The video transcoding and retransmitting unit 207 may transcode the multilayer video bitstream to be suitable for an interface environment of a neighboring terminal that communicates with the channel adaptive hierarchical broadcast reception apparatus 200, and may retransmit the transcoded multilayer video bitstream to the neighboring terminal. The channel adaptive hierarchical broadcast reception apparatus 200 may include, for example, a set-top box (STB) of a smart television (TV), and the neighboring terminal may include, for example, a smartphone, or a tablet personal computer (PC).

According to embodiments of the present invention, different physical channels may be used to transmit an encoded multilayer video, and accordingly a conventional problem occurring when a service is interrupted since a single transmission channel is not available may be solved. Thus, it is possible to provide a seamless video service.

Additionally, according to embodiments of the present invention, different physical channels may be simultaneously used to transmit an encoded multilayer video, and accordingly a high-quality image service that has been impossible when a bandwidth of a single channel is reduced, may be equally provided using multiple transmission channels. Thus, it is possible to adaptively provide a high-quality video service.

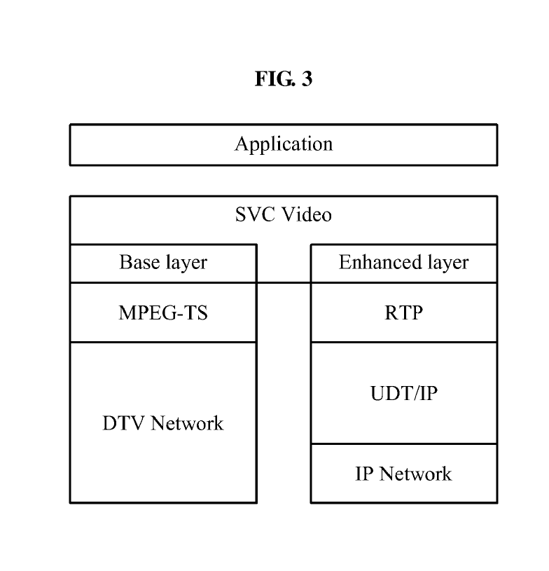

FIG. 3 is a diagram illustrating a structure of a peer-to-peer (P2P) protocol used in a channel adaptive hierarchical broadcast transmission apparatus and a channel adaptive hierarchical broadcast reception apparatus using multiple transmission channels according to an embodiment of the present invention.

Referring to FIG. 3, the channel adaptive hierarchical broadcast transmission apparatus and the channel adaptive hierarchical broadcast reception apparatus may transmit and receive a video of a base layer (for example, a first layer video bitstream), using an MPEG2-TS protocol that is located above a digital television (DTV) network, in association with a broadcast network. Additionally, the channel adaptive hierarchical broadcast transmission apparatus and the channel adaptive hierarchical broadcast reception apparatus may transmit and receive a video of an enhanced layer (for example, a second layer video bitstream), using a real-time transport protocol (RTP) that is located above an Internet protocol (IP) network and a user datagram protocol (UDP)/IP, in association with an Internet network.

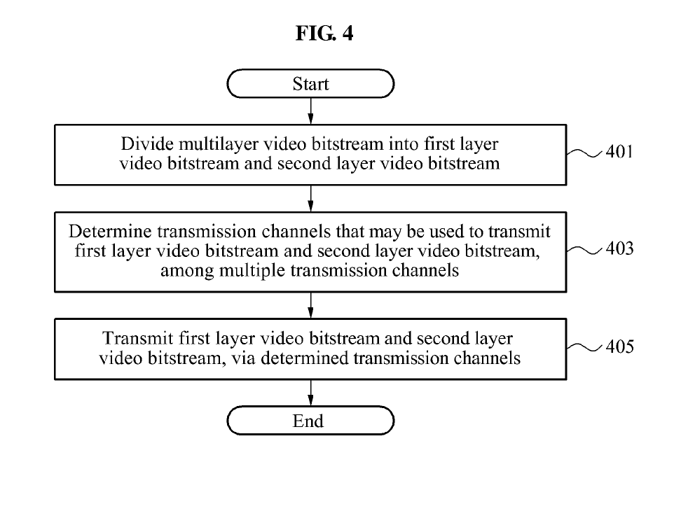

FIG. 4 is a flowchart illustrating a channel adaptive hierarchical broadcast transmission method using multiple transmission channels according to an embodiment of the present invention.

Referring to FIG. 4 in operation 401, a channel adaptive hierarchical broadcast transmission apparatus may receive, as an input, a video source (for example, HD video, UHD video, and 3D video) from an Internet content web server and a real-time broadcast system, may encode the received video source based on an initial setting value, may generate a multilayer video bitstream, and may divide the generated multilayer video bitstream into a first layer video bitstream and a second layer video bitstream. In this instance, the channel adaptive hierarchical broadcast transmission apparatus may divide the multilayer video bitstream into the first layer video bitstream and the second layer video bitstream, based on layers.

Prior to the encoding, the channel adaptive hierarchical broadcast transmission apparatus may receive, as inputs, an initial setting value for scalable video coding (SVC) (for example, a number of layers, and scalability of space, time, and an image quality), and a default value for a channel of layered video.

In operation 403, the channel adaptive hierarchical broadcast transmission apparatus may determine transmission channels that may be used to transmit the first layer video bitstream and the second layer video bitstream, among the multiple transmission channels. The multiple transmission channels may include, for example, a first transmission channel based on a broadcast network, and a second transmission channel based on an Internet network.

For example, the channel adaptive hierarchical broadcast transmission apparatus may determine the first transmission channel (for example, the broadcast network) as a transmission channel to be used to transmit the first layer video bitstream, and may determine the second transmission channel (for example, the Internet network) as a transmission channel to be used to transmit the second layer video bitstream.

In this instance, the channel adaptive hierarchical broadcast transmission apparatus may receive channel information from a channel adaptive hierarchical broadcast reception apparatus, and may determine a transmission channel that may be used to transmit each of the first layer video bitstream and the second layer video bitstream, based on the received channel information. The channel information may include, for example, information on an entire bandwidth that is currently receivable, and information on an available bandwidth for each transmission channel.

In operation 405, the channel adaptive hierarchical broadcast transmission apparatus may transmit the first layer video bitstream and the second layer video bitstream to the channel adaptive hierarchical broadcast reception apparatus, via the determined transmission channels, respectively.

For example, the channel adaptive hierarchical broadcast transmission apparatus may use an MPEG2-TS protocol to transmit the first layer video bitstream via the first transmission channel based on the broadcast network, and may use an RTP to transmit the second layer video bitstream via the second transmission channel based on the Internet network.

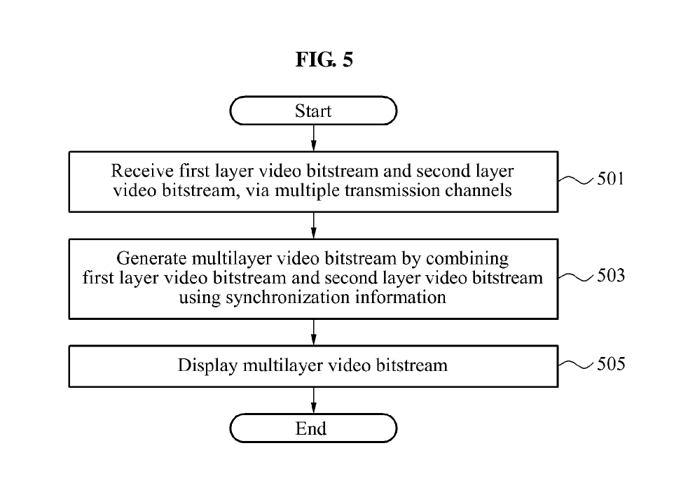

FIG. 5 is a flowchart illustrating a channel adaptive hierarchical broadcast reception method using multiple transmission channels according to an embodiment of the present invention.

Referring to FIG. 5, in operation 501, a channel adaptive hierarchical broadcast reception apparatus may receive a first layer video bitstream and a second layer video bitstream from a channel adaptive hierarchical broadcast transmission apparatus, via multiple transmission channels. In this instance, the channel adaptive hierarchical broadcast reception apparatus may receive, from the channel adaptive hierarchical broadcast transmission apparatus, the first layer video bitstream and the second layer video bitstream via a first transmission channel (for example, a broadcast network) and a second transmission channel (for example, an Internet network), respectively.

In operation 503, the channel adaptive hierarchical broadcast reception apparatus may generate a single multilayer video bitstream, by combining the first layer video bitstream and the second layer video bitstream, using synchronization information.

In this instance, the channel adaptive hierarchical broadcast reception apparatus may extract synchronization information from each of the first layer video bitstream and the second layer video bitstream that are classified based on layers, and may combine the first layer video bitstream and the second layer video bitstream, using the extracted synchronization information, to generate a single multilayer video bitstream.

In operation 505, the channel adaptive hierarchical broadcast reception apparatus may display the generated multilayer video bitstream.

The channel adaptive hierarchical broadcast reception apparatus may transcode the multilayer video bitstream to be suitable for an interface environment of a neighboring terminal that communicates with the channel adaptive hierarchical broadcast reception apparatus, and may retransmit the transcoded multilayer video bitstream to the neighboring terminal. The channel adaptive hierarchical broadcast reception apparatus may include, for example, an STB of a smart TV, and the neighboring terminal may include, for example, a smartphone, or a tablet PC.

Additionally, the channel adaptive hierarchical broadcast reception apparatus may generate channel information regarding the multiple transmission channels, namely the first transmission channel and the second transmission channel, and may provide the generated channel information to the channel adaptive hierarchical broadcast transmission apparatus, to provide an environment that enables transceiving of a video bitstream to be optimized for a state of a transmission channel. The channel information may include, for example, information on an entire bandwidth that is currently receivable, and information on an available bandwidth for each transmission channel.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A channel adaptive hierarchical broadcast transmission apparatus, comprising:
a multilayer video dividing unit to divide an input multilayer video bitstream into a first layer video bitstream and a second layer video bitstream; and
a multi-transmission channel managing unit to determine transmission channels that are to be used to transmit the first layer video bitstream and the second layer video bitstream, among multiple transmission channels, and to output the first layer video bitstream and the second layer video bitstream to transmitters associated with the determined transmission channels, respectively.

2. The channel adaptive hierarchical broadcast transmission apparatus of claim 1, wherein the multilayer video dividing unit divides the multilayer video bitstream into the first layer video bitstream and the second layer video bitstream, based on layers.

3. The channel adaptive hierarchical broadcast transmission apparatus of claim 1, wherein the multi-transmission channel managing unit receives channel information regarding the multiple transmission channels from a channel adaptive hierarchical broadcast reception apparatus, and determines, based on the received channel information, the transmission channels that are to be used to transmit the first layer video bitstream and the second layer video bitstream.

4. The channel adaptive hierarchical broadcast transmission apparatus of claim 1, wherein the multiple transmission channels comprise a first transmission channel based on a broadcast network, and a second transmission channel based on an Internet network, and
wherein the multi-transmission channel managing unit determines the first transmission channel as a transmission channel to be used to transmit the first layer video bitstream, and determines the second transmission channel as a transmission channel to be used to transmit the second layer video bitstream.

5. A channel adaptive hierarchical broadcast reception apparatus, comprising:
a receiver to receive a first layer video bitstream and a second layer video bitstream from a channel adaptive hierarchical broadcast transmission apparatus, via multiple transmission channels;
a video synchronization processor to extract synchronization information from each of the first layer video bitstream and the second layer video bitstream, to combine the first layer video bitstream and the second layer video bitstream using the extracted synchronization information, and to generate a multilayer video bitstream; and
a display processor to display the generated multilayer video bitstream.

6. The channel adaptive hierarchical broadcast reception apparatus of claim 5, wherein the video synchronization processor combines the first layer video bitstream and the second layer video bitstream that are classified based on layers, to generate the multilayer video bitstream.

7. The channel adaptive hierarchical broadcast reception apparatus of claim 5, further comprising:
a transmission channel monitoring and transmission controller to generate channel information regarding the multiple transmission channels, and to transmit the generated channel information to the channel adaptive hierarchical broadcast transmission apparatus.

8. The channel adaptive hierarchical broadcast reception apparatus of claim 5, wherein the multiple transmission channels comprise a first transmission channel based on a broadcast network, and a second transmission channel based on an Internet network, and
wherein the receiver comprises:
a first receiver to receive the first layer video bitstream via the first transmission channel; and
a second receiver to receive the second layer video bitstream via the second transmission channel.

9. A channel adaptive hierarchical broadcast transmission method, comprising:
dividing an input multilayer video bitstream into a first layer video bitstream and a second layer video bitstream;
determining transmission channels that are to be used to transmit the first layer video bitstream and the second layer video bitstream, among multiple transmission channels; and
transmitting the first layer video bitstream and the second layer video bitstream via the determined transmission channels, respectively.

10. The channel adaptive hierarchical broadcast transmission method of claim 9, wherein the dividing comprises dividing the multilayer video bitstream into the first layer video bitstream and the second layer video bitstream, based on layers.

11. The channel adaptive hierarchical broadcast transmission method of claim 9, wherein the determining comprises receiving channel information regarding the multiple transmission channels from a channel adaptive hierarchical broadcast reception apparatus, and determining, based on the received channel information, the transmission channels that are to be used to transmit the first layer video bitstream and the second layer video bitstream.

12. The channel adaptive hierarchical broadcast transmission method of claim 9, wherein the multiple transmission channels comprise a first transmission channel based on a broadcast network, and a second transmission channel based on an Internet network, and
wherein the determining comprises determining the first transmission channel as a transmission channel to be used to transmit the first layer video bitstream, and determining the second transmission channel as a transmission channel to be used to transmit the second layer video bitstream.

13. A channel adaptive hierarchical broadcast reception method, comprising:
receiving a first layer video bitstream and a second layer video bitstream from a channel adaptive hierarchical broadcast transmission apparatus, via multiple transmission channels;
extracting synchronization information from each of the first layer video bitstream and the second layer video bitstream, combining the first layer video bitstream and the second layer video bitstream using the extracted synchronization information, and generating a multilayer video bitstream; and
displaying the generated multilayer video bitstream.

14. The channel adaptive hierarchical broadcast reception method of claim 13, wherein the extracting comprises combining the first layer video bitstream and the second layer video bitstream that are classified based on layers, to generate the multilayer video bitstream.

15. The channel adaptive hierarchical broadcast reception method of claim 13, further comprising:
generating channel information regarding the multiple transmission channels, and transmitting the generated channel information to the channel adaptive hierarchical broadcast transmission apparatus.

16. The channel adaptive hierarchical broadcast reception method of claim 13, wherein the multiple transmission channels comprise a first transmission channel based on a broadcast network, and a second transmission channel based on an Internet network, and
wherein the receiving comprises:
receiving the first layer video bitstream via the first transmission channel; and
receiving the second layer video bitstream via the second transmission channel.
